(19) United States
(12) Patent Application Publication
(10) Pub. No.: US 2015/0178688 A1
(43) Pub. Date: Jun. 25, 2015

(54) APPOINTMENT SCHEDULING

(71) Applicant: Xerox Corporation, Norwalk, CT (US)

(72) Inventor: Steven R. Moore, Pittsford, NY (US)

(73) Assignee: Xerox Corporation, Norwalk, CT (US)

(21) Appl. No.: 14/138,755

(22) Filed: Dec. 23, 2013

(51) Int. Cl. G06Q 10/10

(52) U.S. Cl. CPC G06Q 10/1095

(57) ABSTRACT

A proposed appointment time may be selected by determining a timeframe for a proposed appointment, where the proposed appointment is at least one month from a current time. After a first period of time, a request to narrow the timeframe for the proposed appointment may be sent to a client device. A response to the request to narrow the timeframe may be received. After a second period of time, a proposed appointment may be selected within the narrowed time frame and a request including the proposed appointment time may be sent to the client. A response to the request may confirm the proposed appointment time or suggest an alternative appointment time.

### TECHNICAL FIELD

One or more of the presently disclosed embodiments are directed to scheduling of appointments.

### BACKGROUND

There are many customer/supplier business relationships where a customer needs to schedule an appointment far in the future, for example, one or more months from a current date. However, it is difficult for a customer to know what the customer's schedule is, thus, making it difficult to know whether the customer is actually going to be available for the appointment.

This may result in customers needing to reschedule appointments for times where there may not be sufficient availability of the supplier to accommodate the customer's schedule.

### SUMMARY

According to some aspects illustrated herein, there is provided a computer-implemented method, including determining a timeframe for an appointment; after a first period of time, sending, to a client device, a request to narrow the timeframe for the appointment; receiving a response to the request to narrow the timeframe; after a second period of time, sending, to the client device, a request including a proposed appointment time, the proposed appointment time being within the narrowed timeframe; and receiving a response to the request including the proposed appointment time, the response confirming the proposed appointment time or suggesting an alternative appointment time.

According to some alternative aspects illustrated herein, there is provided a device including storage to store an appointment schedule; an appointment selector to generate one or more communications to a client device to narrow an appointment timeframe, receive responses to the one or more communications to the client device to narrow the appointment timeframe, and select a proposed appointment time based on the narrowed appointment timeframe; and an appointment schedule manager to manage the appointment schedule and to update information stored in the appointment schedule based on the responses received from the client device.

According to some alternative aspects illustrated herein, there is provided a non-transitory computer-readable storage medium comprising instruction that cause one or more processors to perform a method to determine a timeframe for a proposed appointment, the proposed appointment being at least one month from a current time; after a first period of time, send to a client device a request to narrow the timeframe for the proposed appointment; receive a response to the request to narrow the timeframe; after a second period of time, select the proposed appointment within the narrowed time frame and send to the client device a request including the proposed appointment time; and receive a response to the request including the proposed appointment time, the response confirming the proposed appointment time or suggesting an alternative appointment time.

### BRIEF DESCRIPTION OF THE DRAWINGS

The accompanying drawings, which are incorporated in and constitute a part of this specification, illustrate several examples and together with the description, serve to explain the principles of the disclosed examples. In the drawings:

FIG. 1 is a diagram depicting an example network arrangement in accordance with some examples of the present disclosure;

FIG. 2 is a diagram depicting an example block diagrams of components of a computing device that may be used to perform one or more of the processes as described herein, in accordance with some examples of the present disclosure;

FIG. 3 is an example flow diagram of a process for selecting a proposed appointment time, in accordance with one or more examples as discussed herein;

FIG. 4 is an example diagram depicting a timeline in scheduling an appointment, in accordance with one or more examples as discussed herein; and

FIG. 5 depicts an example block diagram of a computing device, in accordance with one or more examples as discussed herein.

### DETAILED DESCRIPTION

Reference will now be made in detail to example embodiments, which are illustrated in the accompanying drawings. Where appropriate, the same reference numbers are used throughout the drawings to refer to the same or like parts.

For simplicity and illustrative purposes, the principles of the present teachings are described by referring mainly to exemplary embodiments thereof. However, one of ordinary skill in the art would readily recognize that the same principles are equally applicable to, and can be implemented in, all types of information and systems, to the extent that variations do not depart from the true spirit and scope of the present teachings. Moreover, in the following detailed description, references are made to the accompanying figures, which illustrate specific exemplary embodiments. Electrical, mechanical, logical and structural changes may be made to the exemplary embodiments to the extent that they do not depart from the spirit and scope of the present teachings. The following detailed description is, therefore, not to be taken in a limiting sense and the scope of the present teachings is defined by the appended claims and their equivalents.

It is common for a customer to book an appointment with a supplier that is far in the future. For example, a patient may look to book a next medical appointment six months from the date of the current visit. It may be difficult for the patient to know what commitments he may have that far in the future. This may result in a situation where the patient may need to reschedule the appointment during a time where there are not a lot of options open for available appointments.

As discussed herein, a proposed appointment time may be made based on one or more communications between a customer and a supplier. The initial scheduling may include an identification of a timeframe of an appointment. Based on one or more communications between the supplier and the customer, over one or more periods of time, the timeframe may be narrowed and a proposed appointment may be selected from the narrowed timeframe.

By providing for an initial timeframe that is narrowed over time, it is more likely that the appointment time that is ultimately selected may be a convenient time for the customer and may not need to be rescheduled.

In general, aspects consistent with the present teachings provide methods, systems, apparatus, and non-transitory computer-readable mediums for selecting a proposed appointment time based on one or more communications between a customer device and an appointment scheduling device, wherein an initial timeframe may be narrowed over time in order to select a proposed appointment time.

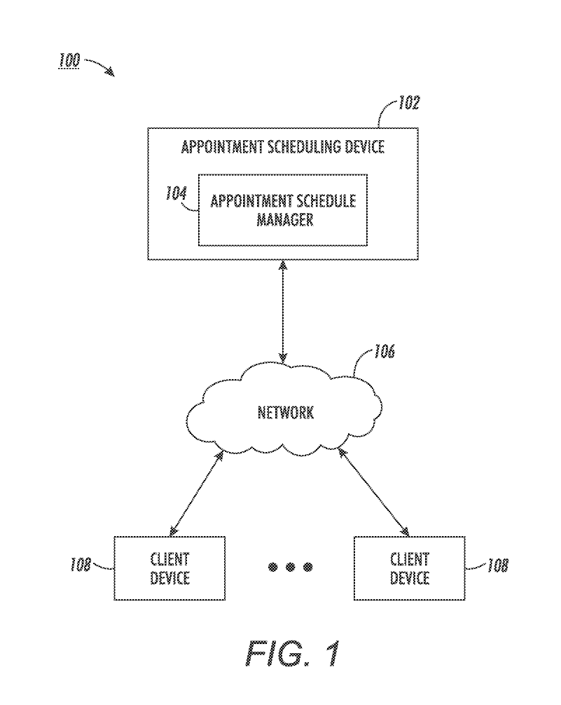

FIG. 1 is a diagram depicting an example system 100 in which appointments may be scheduled. System 100 may include an appointment scheduling device 102 including appointment schedule manager 104. Appointment scheduling device 102 may be implemented as a server, mainframe computing device, any combination of these components, or any other appropriate computing device, resource service, for example, cloud, etc. Appointment scheduling device 102 may be a standalone device, or may be part of subsystem, which, in turn, may be part of a larger system. While appointment scheduling device 102 may be described as including various components, one or more of the components described may be located at other devices, shown or not shown in the figures herein, within system 100.

Appointment scheduling device 102 may be communicably linked to client devices 108 via network 106. Network 106 may include one or more wired networks, for example, local area networks (LANs), wide area networks (WANs), for example the Internet, or any other suitable connections. Network 115 may also provide for wireless communications using wireless protocols, such as wireless Ethernet, Global System for Mobile Communications (GSM), Enhanced Data rates for GSM Evolution (EDGE), Universal Mobile Telecommunications System (UMTS), Worldwide Interoperability for Microwave Access (WiMAX), Long Term Evolution (LTE), etc.

Appointment schedule manager 104 may be one or more applications implemented on a device including one or more processors (not shown) coupled to memory (not shown) to facilitate scheduling of appointments. The processors may include, e.g., a general purpose microprocessor such as the Pentium processor manufactured by Intel Corporation of Santa Clara, Calif.; an application specific integrated circuit that embodies at least part of the method in accordance with certain examples in its hardware and firmware; a mobile device processor, a combination thereof; etc. The memory may be any device capable of storing electronic information, such as RAM, flash memory, a hard disk, an internal or external database, etc. The memory can store instructions adapted to be executed by the processor to perform at least part of the method in accordance with certain embodiments. For example, the memory can store computer software instructions, for example, computer-readable or machine-readable instructions, adapted to be executed on the processor to facilitate scheduling of appointments in addition to other functionality discussed herein.

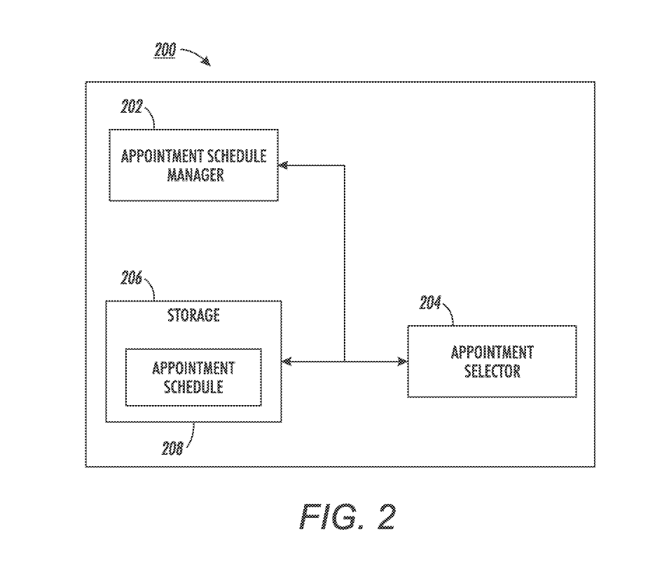

Appointment schedule manager 104 may manage an appointment schedule stored in a storage (not shown). Appointment schedule manager 104 may, in conjunction with appointment selector (FIG. 2), facilitate selection of timeframes for appointments in the future, one or more communications with client devices to narrow the selected timeframes, and selection of proposed appointment times from narrowed timeframes. Appointment schedule manager 104 may further update information stored in the appointment schedule based on information received from client devices 108.

In the example shown in FIG. 1, appointment schedule manager 104 is provided by appointment scheduling device 102. In other examples, the appointment schedule manager 104 may be provided by a third party. In still other examples, appointment schedule manger 104 may be located on client device 108 or may be stored on another server or computer (not shown) connected to network 106.

Client devices 108 may be a laptop or desktop computer, a smartphone, a tablet or any other suitable computing device. Client devices 108 may include one or more software applications (not shown) that execute on client devices 108 and may be controlled by a user, such as a natural person seeking to schedule an appointment. The user may provide input, via a graphical user interface, which may include a timeframe, a narrowed timeframe, confirmation of a proposed appointment time, an alternative proposed appointment time, etc., via client device 108. It may be appreciated that while only two client devices 108 are depicted, other client devices may reside within system 100.

According to one or more examples, client device 108 may be implemented as a telephone or smartphone where communication may be implemented via voice, or other input via the telephone or smartphone keypad, in order to facilitate the processes as discussed herein. Voice input or input via the telephone keypad may be received at the appointment scheduling device and processed in order facilitate appointment scheduling as discussed herein

FIG. 2 shows an example block diagram of appointment scheduling device 200 consistent with one or more examples as discussed herein. As shown in FIG. 2, appointment scheduling device 200 includes appointment schedule manager 202, appointment selector 204, storage 206 and appointment schedule 208.

Appointment schedule manager 202 manages the appointment schedule 208 stored in storage 206 by adding, modifying, and removing appointments stored in appointment schedule 208. Appointment schedule manager 202 may manage appointment schedule 208 based on information received from client devices, for example, client devices 108 via network 106, via input received at a user interface (not shown) at device 200, or via other suitable means, not shown.

Appointment manager 202 may communicate with appointment selector 204 by accessing appointment information from appointment schedule 208 stored in storage 206 and passing appointment information accessed from appointment schedule 208 to appointment selector 204.

Appointment selector 204 may select a proposed appointment time by starting with an appointment timeframe and narrowing the appointment timeframe over time. For example, when a customer is looking to schedule an appointment, an initial timeframe of the appointment may be selected. The timeframe may be selected based on information received from the customer, it may be selected based on a default time of when the next appointment should be scheduled, it may be selected by an administrator at, for example, appointment scheduling device 102, etc. For example, where a customer is looking scheduling a next dentist appointment, the appointment selector 204 may select a time frame, for example, one month, that is six to seven months from the current date, as dental checkups should be conducted around every six months.

After a first time period has passed from the selection of the appointment timeframe, the appointment selector 204 may generate and initiate sending a communication to a client device of the customer. The communication may include a request to narrow the appointment timeframe. This request may be sent with the assumption that the customer has more information about his schedule than he did when the appointment timeframe was selected.

The appointment selector may receive a response to the request from the client device. The response may include a narrowed timeframe. The timeframe may be narrowed in that: one or more particular dates may be removed from the timeframe, the boundaries of the timeframe may be narrowed, for example, from one month to two weeks, etc. The narrowed timeframe may be passed to the appointment schedule manager 202 where the appointment schedule manager 202 may update the appointment schedule 208 in storage 206 with the narrowed timeframe from the client device.

After a second time period has passed from the generation and sending of the communication including the request to narrow the appointment timeframe, the appointment selector 204 may select a proposed appointment time based on communication with appointment manager 202. In some examples, the appointment selector 204 may receive available appointment times during the narrowed timeframe and may select a proposed appointment time according to a selection algorithm. In other examples, the appointment schedule manager may access available appointment times in the narrowed timeframe and select a proposed appointment time based on a selection algorithm. The selection algorithm may include selecting the first available appointment, randomly selecting an appointment, selecting an appointment based on stored preferences, etc.

After the proposed appointment time has been selected, the appointment selector 204 may generate and initiate sending a communication to the client device, for example, client device 108 including the selected proposed appointment time. Once a response to the request including the proposed appointment time is received from the client device 108, the appointment selector 204 may determine from the response whether the proposed appointment time has been confirmed, or if an alternative proposed appointment time is included in the response.

If the proposed appointment time has been confirmed, the information is passed to the appointment schedule manager 202 to update the appointment schedule 208.

If an alternative proposed appointment is included, the appointment selector 204 communicates with appointment schedule manager 202 to determine if the alternative proposed appointment is available. If it is available, the appointment selector 204 confirms the alternative proposed appointment with the client device. If the alternative proposed appointment is not available, a different proposed appointment time is selected based on one of the selection algorithms discussed above and the appointment selector 204 generates and initiates a communication to the client device including the different proposed appointment.

Time periods for generating and sending communications between device 200 and client devices in addition to default values for selecting appointment timeframes may be stored in storage 206.

In accordance with some examples, additional communications may be generated and sent to the client device in order to further narrow the appointment timeframe. For example, after a third period of time, the appointment selector 204 may generate and initiate sending a communication to the client device, where the communication includes a request to further narrow the appointment timeframe. The appointment selector 204 may receive a response to the request, where the response includes a further narrowed timeframe. The further narrowed timeframe may be passed to appointment schedule manager 202 in order to update the appointment schedule. In these examples, a proposed appointment may be selected from the further narrowed timeframe.

In accordance with some examples, one or more further communications may be sent after additional time period(s) in order to further narrow the appointment timeframe wherein a proposed appointment may be selected from the further narrowed timeframe.

While FIG. 2 shows storage 206 included in device 200, this storage may be stored separately and accessed remotely by appointment schedule manager 202. For example, appointment schedule manager 202 may access storage 206 via network 106, as shown in the example in FIG. 1.

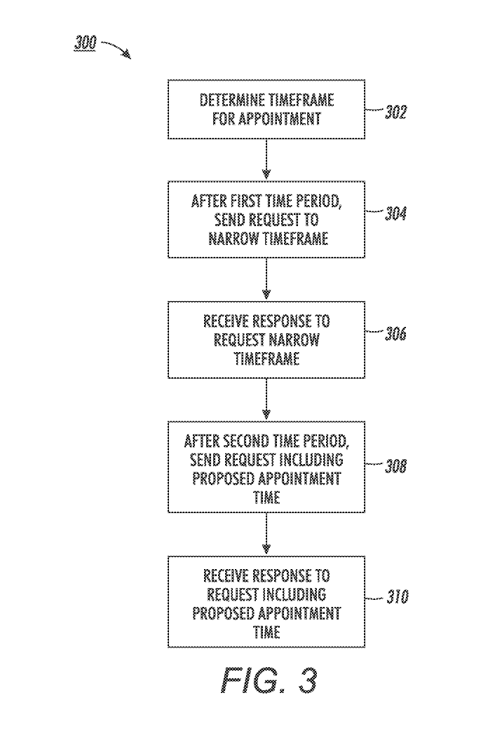

FIG. 3 is an example flow diagram of a process 300 for selecting a proposed appointment, in accordance with one or more examples herein. Appointment selector 204 may perform one or more of the steps included in process 300. One or more of the steps included in process 300 may likewise be performed by other components of device 200, e.g., by appointment schedule manager 202, or by other components within system 100, for example, by client device 108, and/or any combination thereof.

As shown in FIG. 3, a timeframe for an appointment may be determined 302. According to some examples, the timeframe may be determined based on input received via a graphical user interface.

According to some examples, the timeframe may be determined based on default values stored in a storage. For example, different types of suppliers may have associated therewith default values as to when a next appointment should be scheduled. Where the supplier is a dentist, and a patient is looking to schedule a next cleaning, the default value may be six months. In another example, where the supplier is a primary care physician, and the patient is looking to schedule a next routine physical examination, the default value maybe twelve months. Thus, a storage may have stored therein default values associated with a type of appointment that is to be scheduled. The default value may be accessed based on the type of appointment that is to be scheduled.

The appointment timeframe may be determined based on the default time that is accessed from storage, based on input received via the graphical user interface, etc. The default value, or value received via the graphical user interface may be the start of the appointment timeframe. A predetermined amount of time may be added to determine the end of the appointment timeframe, for example, 1 week, 1 month, etc. In some examples, the predetermined timeframe may vary based on how far out the appointment is to be scheduled. Thus, if the appointment is to take place within two months, a shorter timeframe may be provided, for example, two weeks, where if the appointment is to take place in six months, a one month timeframe may be provided.

The determined timeframe may then be updated in the appointment schedule 208 by appointment schedule manager 202.

After a first time period, a request may be sent to narrow the appointment timeframe. Appointment selector 204 may send a request to a client device to narrow the appointment timeframe 304. There is an expectation that as the appointment timeframe gets closer in time, the customer may have more information about his availability during the appointment timeframe. Thus, as the appointment timeframe gets closer, appointment selector 204 may communicate with a client device in an effort to narrow the appointment timeframe based on the customer's availability.

One or more time periods may be stored in association with each of the appointment types. The time periods may indicate when communications are to be sent to assist in narrowing the appointment timeframe and when to select a proposed appointment time. Thus, appointment selector 204 may monitor the time such that after a time period has passed, the appointment selector may generate a communication. The communication may include a request to narrow the determined appointment timeframe.

A response to the request to narrow the appointment time frame may be received 306. The appointment selector 204 may receive the response to the request to narrow the timeframe. The narrowed information may be passed to the appointment schedule manager 202. Appointment schedule manager 202 may update the appointment schedule based on the information included in the response.

After a second time period, a request may be sent, where the request includes a proposed appointment time 308. After a second time period, a proposed appointment time may be selected. The proposed appointment time may be selected by, for example, appointment selector 204, appointment schedule manager 202, etc., based on the narrowed appointment timeframe stored in appointment schedule 208. The proposed appointment time may be selected by one of multiple selection algorithms, for example, first available, random selection, etc. Appointment selector 204 may generate a communication including the proposed appointment time and may initiate sending of the communication to client device.

A response to the request including the proposed appointment time may be received 310. The response may include information that confirms the proposed appointment time, suggests an alternative appointment time, requests additional information regarding the appointment, etc. Appointment selector 204 may receive the request and determine whether the proposed appointment time was confirmed or not. If the appointment time is confirmed, the information is passed to appointment schedule manager 202 and the appointment schedule is updated with the information. If the proposed appointment time was not confirmed, and an alternative proposed appointment time is proposed, appointment selector 204 may communicate with appointment schedule manager 202 to determine if the alternative appointment time is available. If it is available, then the appointment schedule is updated and the appointment selector 204 generates and initiates sending a communication to the client device to confirm the alternative proposed appointment time. If the alternative proposed appointment time is not available, a different proposed appointment time is selected based on a selection algorithm and communicated to the client device. Processing proceeds in this fashion until a satisfactory appointment time is confirmed.

According to some examples, one or more communications may be received unprompted (sua sponte) from a client device including information narrowing the appointment timeframe. The one or more communications may be received even though they are not in response to a request from appointment selector 204. Where one or more communications are received, the narrowed appointment timeframe information may be passed from the appointment selector 204 to appointment schedule manager 202 in order to update the appointment schedule.

The following describes how the scheduling of appointments occurs. Suppose the possible appointment slots within a work week are identified as follows:

| Day & Time | Slot ID |
|---|---|
| Monday 8:00 | 1 |
| Monday 8:30 | 2 |
| Monday 9:00 | 3 |
| . | . |
| . | . |
| . | [symbol] |
| . | . |
| Friday 16:00 | 79 |
| Friday 16:30 | 80 |

Further, suppose each patient to be booked within this timeframe is identified as patient 1, 2, 3, . . . j.

An availability matrix Aᵢⱼ may be defined, where each element aᵢⱼ=1 if patient j is available for appointment i; else=0 if the patient is not available.

Assigning of appointments then proceeds from the most constrained patient, for example, having the least availability, to the least constrained patient, for example, having the most availability, and starting with the most constrained patient. A valid booking is, for example, using the random assignment selection algorithm, randomly assigned for this patient j to available timeslot i. The assignment process is repeated for the next-most constrained patient using the reduced set of timeslots, and so on, until either: 1) Each patient j has a valid timeslot i. Note this represents a valid schedule for the timeframe given current demands and constraints; or 2) at least one patient j does not have a valid timeslot i, in which case this particular schedule solution is discarded. If the schedule solution is discarded, processing begins again with the most constrained patient until a schedule solution is found. If no schedule solution is found, then the most optimal solution, for example, the solution in which the highest number of patients have a valid timeslot, may be kept, and the remaining patients may be rescheduled to a new timeframe.

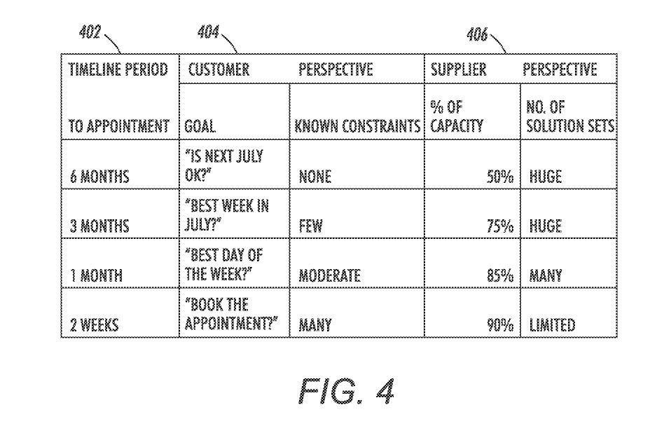

FIG. 4 depicts an example of a timeline prior to an appointment. As shown in FIG. 4, the timeline prior to the appointment 402, customer perspective 404 and supplier perspective 406 is provided. From the customer perspective, as time elapses, and proceeds closer to the next appointment time, the customer's knowledge of his/her schedule in the vicinity of the next appointment grows, thus the known constraints progresses from no known constraints at 6 months, to many known constraints 2 weeks from the appointment time.

From the supplier's perspective, the total demand, or % of capacity, increases as time elapses. For a month ‘far’ in the future, for example, 6 months out, the supplier has a finite number of appointments that can be honored. The majority of these may be filled by customer demands for recurring appointments. The demand for these recurring appointments is known perhaps 3-6 months in advance. So the “% capacity” of the supplier will increase as the supplier commits to more recurring appointments. However, there may initially be very few customer schedule constraints that are known. Thus the supplier has a huge number of possible solution sets of schedules that satisfy all customer constraints. Over time, the supplier solicits and receives more customer constraints. The number of possible solution sets of schedules satisfying all constraints is narrowed. It may still be a relatively large number, since the supplier has not yet locked in specific timeslots; customers with few constraints can have their appointments placed wherever needed to satisfy the overall demand. According to some examples, the supplier may choose to not book to 100% of capacity but leave a predefined number of open timeslots in order to accommodate emergency or walk-in customers.

FIG. 4 further depicts the narrowing of the appointment timeframe to a proposed appointment time as the timeline progresses to the appointment time.

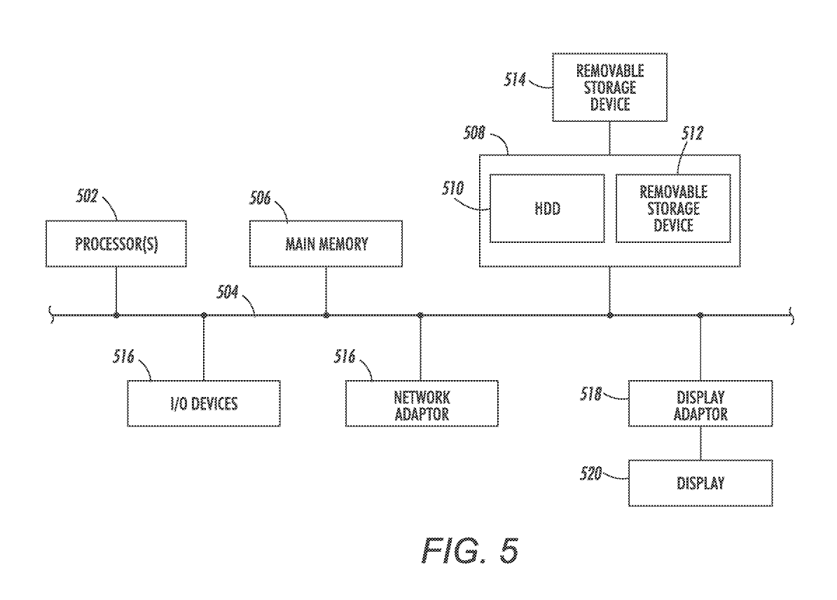

FIG. 5 illustrates a block diagram of a computing apparatus 500, such as the appointment scheduling device 102 depicted in FIG. 1, according to an example. In this respect, the computing apparatus 500 may be used as a platform for executing one or more of the functions described hereinabove.

The computing apparatus 500 includes one or more processors 502. The processor(s) 502 may be used to execute some or all of the steps described in the method depicted in FIG. 3 and among other places in this specification. The processor(s) 502 may be of varying core configurations and clock frequencies. Commands and data from the processor(s) 502 are communicated over a communication bus 504. The computing apparatus 500 also includes a main memory 506, such as a random access memory (RAM), where the program code for the processor(s) 502, may be executed during runtime, and a secondary memory 508. The secondary memory 508 may includes, for example, one or more hard disk drives 510 and/or a removable storage drive 512, representing a floppy diskette drive, a magnetic tape drive, a compact disk drive, etc., where a copy of the program code in the form of computer-readable or machine-readable instructions for the appointment schedule manager and appointment selector to execute the method depicted in FIG. 3 may be stored. The storage device(s) as discussed herein may comprise a combination of non-transitory, volatile or nonvolatile memory such as random access memory (RAM) or read only memory (ROM).

The removable storage drive 510 may read from and/or writes to a removable storage unit 514 in a well-known manner. User input and output devices 516 may include a keyboard, a mouse, touchpad, touchscreen, a display, etc., for facilitating and enabling human interaction with and manipulation of computing apparatus 500. A display adaptor 518 may interface with the communication bus 504 and the display 520 and may receive display data from the processor(s) 502 and convert the display data into display commands for the display 520. In addition, the processor(s) 502 may communicate over a network, for instance, the Internet, LAN, etc., through a network adaptor 522. Network adaptor may be implemented as one or more network interfaces for communicating via one or more networks, such as Ethernet adapters, wireless transceivers, or serial network components, for communicating over wired or wireless media using protocols, such as Ethernet, wireless Ethernet, Global System for Mobile Communications (GSM), Enhanced Data rates for GSM Evolution (EDGE), Universal Mobile Telecommunications System (UMTS), Worldwide Interoperability for Microwave Access (WiMAX), Long Term Evolution (LTE), etc.

Examples described above can be performed as a computer applications or programs. The computer program can exist in a variety of forms both active and inactive. For example, the computer program can exist as one or more software programs, software modules, or both that can be comprised of program instructions in source code, object code, executable code or other formats; firmware program(s); or hardware description language (HDL) files. Any of the above can be embodied on a non-transitory computer medium, which include non-transitory computer readable storage devices and media, and signals, in compressed or uncompressed form. Example non-transitory computer readable storage devices and media include computer system RAM (random access memory), ROM (read-only memory), EPROM (erasable, programmable ROM), EEPROM (electrically erasable, programmable ROM), and magnetic or optical disks or tapes.

According to some examples, the components of computing apparatus 500 need not be enclosed within a single enclosure or even located in close proximity to one another. Those skilled in the art will appreciate that the above-described componentry are examples only, as computing apparatus 500 can include any type of hardware componentry, including any necessary accompanying firmware or software, for performing the disclosed embodiments. Computing apparatus 500 can also be implemented in part or in whole by electronic circuit components or processors, such as application-specific integrated circuits (ASICs) or field-programmable gate arrays (FPGAs).

The foregoing descriptions have been presented for purposes of illustration and description. They are not exhaustive and do not limit the disclosed examples to the precise form disclosed. Modifications and variations are possible in light of the above teachings or may be acquired from practicing the disclosed examples. For example, the described implementation includes software, but the disclosed examples may be implemented as a combination of hardware and software or in firmware. Examples of hardware include computing or processing systems, including personal computers, servers, laptops, mainframes, micro-processors, and the like. Additionally, although disclosed aspects are described as being stored in a memory on a computer, one skilled in the art will appreciate that these aspects can also be stored on other types of computer-readable storage media, such as secondary storage devices, like hard disks, floppy disks, a CD-ROM, USB media, DVD, or other forms of RAM or ROM.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), XML, Java, C++, JavaScript, HTML, HTML/AJAX, Flex, Silverlight, or any other now known or later created programming language. One or more of such software sections or modules can be integrated into a computer system or existing browser software.

Other examples will be apparent to those skilled in the art from consideration of the specification and practice of the examples disclosed herein. The recitations in the claims are to be interpreted broadly based on the language employed in the claims and not limited to examples described in the present specification or during the prosecution of the application, which examples are to be construed non-exclusive. It is intended, therefore, that the specification and examples be considered as example(s) only, with a true scope and spirit being indicated by the following claims and their full scope equivalents.

While the teachings have been described with reference to the examples thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the terms “one or more of” and “at least one of” with respect to a listing of items such as, for example, A and B, means A alone, B alone, or A and B. Those skilled in the art will recognize that these and other variations are possible within the spirit and scope as defined in the following claims and their equivalents.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method, comprising:
determining a timeframe for an appointment;
after a first period of time, sending, to a client device, a request to narrow the timeframe for the appointment;
receiving a response to the request to narrow the timeframe;
after a second period of time, sending, to the client device, a request including a proposed appointment time, the proposed appointment time being within the narrowed timeframe; and
receiving a response to the request including the proposed appointment time, the response confirming the proposed appointment time or suggesting an alternative appointment time.

2. The computer-implemented method of claim 1, further comprising:
updating a storage with the narrowed timeframe; and
selecting the proposed appointment time based on the stored narrowed timeframe.

3. The computer-implemented method of claim 1, further comprising:
randomly selecting the proposed appointment time within the narrowed timeframe.

4. The computer-implemented method of claim 1, further comprising:
selecting a first available appointment time within the narrowed timeframe as the proposed appointment time.

5. The computer-implemented method of claim 1, further comprising:
after a third period of time, sending to the client device a request for a second narrowed time timeframe; and
receiving the second narrowed time frame in response to the request for the second narrowed timeframe.

6. A device comprising:
storage to store an appointment schedule;
an appointment selector to
generate one or more communications to a client device to narrow an appointment timeframe,
receive responses to the one or more communications to the client device to narrow the appointment timeframe, and
select a proposed appointment time based on the narrowed appointment timeframe; and
an appointment schedule manager to manage the appointment schedule and to update information stored in the appointment schedule based on the responses received from the client device.

7. The device of claim 6, wherein the appointment selector is to:
determine a timeframe of an appointment;
after a first period of time, send to the client device a request to narrow the timeframe for the appointment;
receive a response to the request to narrow the timeframe;
after a second period of time, send to the client device a request including a proposed appointment time, the proposed appointment time being within the narrowed timeframe; and
receive a response to the request including the proposed appointment time, the response confirming the proposed appointment time or suggesting an alternative appointment time.

8. The device of claim 7, where the appointment schedule manager is further to:
update information in the appointment schedule based on the responses received from the client device.

9. The device of claim 6, wherein the appointment selector selects the proposed appointment randomly from the appointment schedule within the narrowed timeframe.

10. The device of claim 6, wherein the appointment selector selects the first available appointment from the appointment schedule within the narrowed timeframe.

11. The device of claim 6, where the appointment selector is further to:
after a third period of time, send to the client device a request for a second narrowed time timeframe; and
receive the second narrowed time frame in response to the request for the second narrowed timeframe.

12. A non-transitory computer-readable storage medium comprising instruction that cause one or more processors to perform a method to:
determine a timeframe for a proposed appointment, the proposed appointment being at least one month from a current time;
after a first period of time, send to a client device a request to narrow the timeframe for the proposed appointment;
receive a response to the request to narrow the timeframe;
after a second period of time, select the proposed appointment within the narrowed time frame and send to the client device a request including the proposed appointment time; and
receive a response to the request including the proposed appointment time, the response confirming the proposed appointment time or suggesting an alternative appointment time.

13. The non-transitory computer-readable storage medium of claim 12, the method further to:
update information in the appointment schedule based on the responses received from the client device.

14. The non-transitory computer-readable storage medium of claim 12, wherein the proposed appointment time is selected randomly from the appointment schedule within the narrowed timeframe.

15. The non-transitory computer-readable storage medium of claim 12, wherein the proposed appointment time selected is a first available appointment from the appointment schedule within the narrowed timeframe.

16. The non-transitory computer-readable storage medium of claim 12, wherein the method is further to:
after a third period of time, send to the client device a request for a second narrowed time timeframe; and
receive the second narrowed time frame in response to the request for the second narrowed timeframe.
